(19) United States
(12) Patent Application Publication
(10) Pub. No.: US 2020/0154744 A1
(43) Pub. Date: May 21, 2020

(54) WHOLE-LEGUME FOOD PRODUCT AND METHOD OF MAKING WHOLE-LEGUME FOOD PRODUCT

(71) Applicants: Mark Henry Sterner, Riverside, CA (US); Mark Matthew Sterner, Riverside, CA (US)

(72) Inventors: Mark Henry Sterner, Riverside, CA (US); Mark Matthew Sterner, Riverside, CA (US)

(21) Appl. No.: 16/688,991

(22) Filed: Nov. 19, 2019

Related U.S. Application Data
(60) Provisional application No. 62/770,641, filed on Nov. 21, 2018.

(51) Int. Cl. A23L 11/00; A23L 27/10

(52) U.S. Cl. CPC A23L 11/01; A23L 27/10

(57) ABSTRACT

Whole-legume food products and methods of making whole-legume food products are described.

### CROSS-REFERENCE TO RELATED APPLICATION

This application claims the benefit of U.S. Provisional Application No. 62/770,641, filed Nov. 21, 2018, which is hereby incorporated by reference in its entirety.

### BACKGROUND

Due to a variety of concerns regarding meat products, many people are consuming less meat and more vegetable-based food products. Studies have shown that people eating a largely vegetarian diet live longer than those eating a meat-based diet and have better than average health until death. There are also economic and environmental benefits of eating a largely vegetarian diet. Legumes consume carbon dioxide and fix nitrogen into the soil. Water consumption per pound of legumes is approximately 43 gallons, whereas beef requires approximately 1,857 gallons per pound to produce.

There are vegetable-based products prepared to resemble meat, in terms of taste and appearance. However, man such vegetable-based products are highly processed products formulated using vegetable concentrates, isolates, and, similar to meat, do not contain health benefiting ingredients.

### SUMMARY

Toward that end, in one aspect the present disclosure provides a whole-legume food product generally including dried cooked whole legumes; and a flavoring mixture enrobing the dried cooked whole legumes. As discussed further herein, such a whole-legume food product has organoleptic qualities similar to that of meat and, in this regard, the whole-legume food products of the present disclosure are meat analogs.

In another aspect, the present disclosure provides a method of making a whole-legume food product, the method generally including washing and destoning whole legumes to provide washed and destoned whole legumes; cooking the washed and destoned whole legumes to provide cooked legumes; drying the cooked legumes to provide dried cooked legumes; and enrobing the dried cooked legumes with a flavoring mixture to provide enrobed legumes. Whole-legume food products made by the methods of the present disclosure include meat analogs as described further herein.

The whole-legume food products of the present disclosure, and related methods of making, reduce nutrient loss, such as loss of nutrients, including prebiotic and probiotic nutrients of uncooked legumes. The whole-legume food products further present such nutrients, such as digestible and indigestible fiber, complex carbohydrates, minerals, and antioxidants bio-available for absorption in the digestive system. Furthermore, methods and whole-legume food products of the present disclosure specifically maintain a variety of prebiotic fibers such as Raffinose-family oligosaccharides (RFO), sugar alcohols, fructo-oligosaccharides (FOS), and resistant starch (RS). Medical research indicates that prebiotic fiber play an important role in maintaining the gut health and in the treatment and prevention of a variety of chronic diseases and conditions, mainly diabetes, obesity, mental health and Alzheimer to name a few.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawing, wherein:

FIG. 1 is a schematic block diagram of a method, in accordance with an embodiment of the present disclosure;

FIG. 2A is a schematic illustration of a cooking vessel, in accordance with an embodiment of the present disclosure, shown in an initial configuration loading whole legumes into the cooking vessel with a steam vent in a closed position;

FIG. 2B is a schematic illustration of the cooking vessel of FIG. 2A with the steam valve in an open position and a vent valve in a partially open position, in accordance with an embodiment of the present disclosure;

FIG. 2C is a schematic illustration of the cooking vessel of FIG. 2A with the steam valve in an open position and the vent valve in a closed position, in accordance with an embodiment of the present disclosure;

FIG. 2D is a schematic illustration of the cooking vessel of FIG. 2A shown unloading cooked whole legumes from the cooking vessel with the steam valve in a closed position, in accordance with an embodiment of the present disclosure;

FIG. 3A graphically illustrates L* vs b* in a CIELAB color space for various ground proteins including whole-legume food products, in accordance with an embodiment of the present disclosure;

FIG. 3B graphically illustrates L* vs. a* in a CIELAB color space for the ground proteins of FIG. 3A, in accordance with an embodiment of the present disclosure;

FIG. 3C graphically illustrates a* vs. b* in a CIELAB color space for the ground proteins of FIG. 3A, in accordance with an embodiment of the present disclosure;

FIG. 4 graphically illustrates a comparison of percentage of ground proteins vs. sieve size for prepared ground beef and a whole-legume food product, in accordance with an embodiment of the present disclosure;

FIG. 5 graphically illustrates force applied to ground proteins vs. time for various ground proteins, including a whole-legume food product, in accordance with an embodiment of the present disclosure;

FIG. 6 graphically illustrates force applied to ground proteins vs. time for various ground proteins, including a whole-legume food product, in accordance with an embodiment of the present disclosure; and

FIG. 7 illustrates an exemplary set of sieves for wet sieve analysis used in measuring particle sizes and particle size distributions of the whole-legume food products, in accordance with an embodiment of the disclosure.

### DETAILED DESCRIPTION

The present disclosure is generally directed to whole-legume food products, such as meat analogs, and methods of making whole-legume food products. As discussed further herein, the whole-legume food products of the present disclosure have various qualities, such as color, texture, appearance, and flavor resembling cooked meat products. In this regard, the whole-legume food products of the present disclosure may be used, for example, as meat analogs or replacers to replace, supplement, extend, or fortify meat in preparation of food that would otherwise include meat or include more meat.

The detailed description set forth below in connection with the appended drawing is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

### METHODS

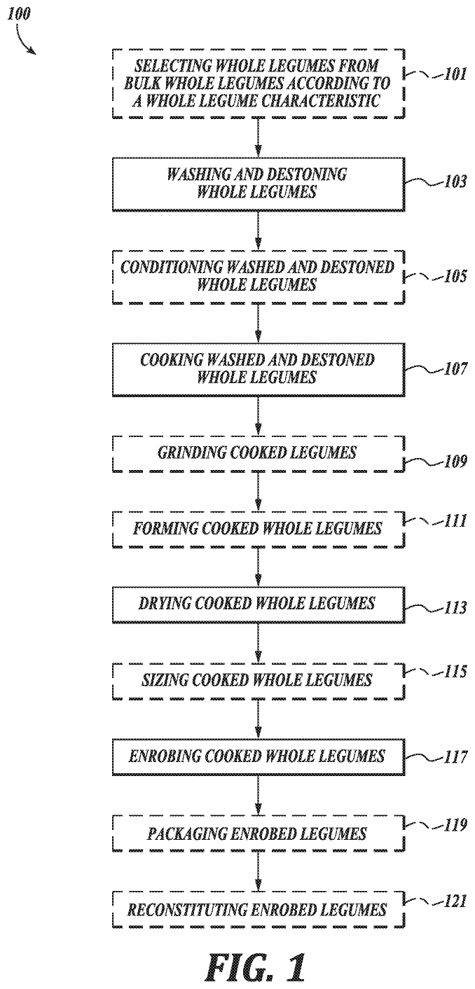

In an aspect, the present disclosure provides a method of making a whole-legume food product. In that regard, attention is directed to FIG. 1, where there is shown an example of a method 100 of making a whole-legume food product, in accordance with an embodiment of the disclosure. In an embodiment, such a whole-legume food product may be a meat analog or suitable to produce a meat analog. As discussed further herein, such whole-legume food products include whole legumes. Such whole-legume food products are in contrast to food products made from, for example, portions of whole legumes. While the whole-legume food products of the present disclosure can include ground whole legumes, such products may further include whole legumes. Such whole legumes may be cooked, dried, and the like, but nevertheless have a structure that is minimally processed such that it includes, for example, an intact seed coat. Further, the whole legume is not and is distinct from a concentrate, fractionate, isolate, and the like based on or derived from a legume or other food product. As used herein, a meat analog refers to a vegetable-based food product having one or more organoleptic qualities, such as taste, color, appearance, odor, texture, size distribution, and feel, of a cooked meat product. Such a meat analog may comprise food products selected from the group consisting of legumes, vegetables, cereals, fruits, nuts, and combinations thereof.

In an embodiment, method 100 begins with process block 101, which includes selecting a food product from a bulk whole food product according a characteristic. In an embodiment, the food product is a whole legume. In an embodiment, the whole legume includes a whole lentil. In an embodiment, whole lentils are selected from the group consisting of French green lentils, petite Estoria lentils, Spanish Pardina lentils, marrow lentils, petite Castillo lentils, lenticche Verdi lentils, black beluga lentils, Richlea lentils, Red Chief lentils, Brewer lentils, Crimson lentils, Large Green lentils, Eston lentils, and Puy lentils. In an embodiment, whole lentils are selected from the group consisting of Brewer, Cedar, Crimson, Essex, Eston, French Green, Greenland, Impact, Merrit, Meteor, Morena, Pardina, Pennell, Redberry, Richlea, Rivland, Shasta, Vantage, and combinations thereof. In an embodiment, the whole lentil is the Madeline variety of the French Green lentil. In an embodiment, the whole lentil is a Canadian marble variety of lentil. In an embodiment, the variety of whole legume is selected for its color, flavor, and/or other characteristics resembling cooked meat. While whole lentils are described further herein, it will be understood that method 100 encompasses other whole legumes. In an embodiment, process block 101 includes selecting whole legumes from bulk whole legumes according to a whole legume characteristic to provide selected whole legumes. In an embodiment, process block 101 is optional.

In an embodiment, selecting whole legumes from bulk whole legumes comprises selecting, from the bulk whole legumes, whole legumes having a size in a size range. Size of the whole legume may determine certain organoleptic qualities of prepared whole-legume food products, such as texture and appearance. As discussed further herein, in an embodiment, the whole legumes are selected from bulk whole legumes such that whole-legume food products prepared by method 100 resemble ground meat, such as for use in preparation of tacos, chili, sloppy joes, casseroles, and the like.

In an embodiment, selecting whole legumes from bulk whole legumes comprises passing a portion of the bulk whole legumes through a screen. Passing the whole legumes through the screen is suitable to select whole legumes having sizes smaller than the diameters of the apertures. In this regard, a size or size range of whole legumes may be selected. In an embodiment, the screen defines a plurality of apertures having diameters in a range of about 20/64^{th} of an inch to about 1/16^{th} of an inch. In an embodiment, the screen defines a plurality of apertures having diameters in a range of about 15/64^{th} of an inch to about 12/64^{th} of an inch.

In an embodiment, selecting whole legumes from bulk whole legumes comprises selecting whole legumes having intact seed coats, such as by removing legumes having cracked seed coats from the bulk whole legumes. Legumes having cracked seed coats tend to cook faster than legumes having intact seed coats. In that regard, a mixture of whole legumes having both cracked and intact seed coats may cook unevenly providing cooked whole legumes having an uneven organoleptic quality, such as an uneven texture, with some whole legumes cooked to a greater degree than others. In an embodiment, the selected whole legumes have a percentage of whole legumes with cracked seed coats in a range of about 0.1% and about 10%. In an embodiment, the selected whole legumes have a percentage of whole legumes with cracked seed coats in a range of about 5% and about 10%.

In an embodiment, the whole legume characteristic of the bulk whole legumes is selected from the group consisting of color, density, shape, and combinations thereof. Such selection may be through an automated process for selecting legumes having the whole legume characteristic.

In an embodiment, selecting whole legumes from bulk whole legumes comprises selecting mature whole legumes, such as by removing immature whole legumes from the bulk whole legumes. Such immature whole legumes may cook differently from mature whole legumes, thus providing an inconsistent cooked whole legume.

Process block 101 may be followed by process block 103, which includes washing and destoning whole legumes to provide washed and destoned whole legumes. Washing and destoning is performed on the bulk whole legumes and/or selected whole legumes to remove stones and other debris and to rinse off dirt and other residue from the whole legumes. Such washing and destoning may remove, for example, aluminum from the whole legumes. In an embodiment, washing and destoning includes agitating the whole legumes on a tilted screen, such as a gravity table. The gravity table is configured to walk heavy stones and heavier debris up the tilted screen while the whole legumes slide down with the aid of the upwelling of forced air through the screen. The stones and heavier debris are discharged through an opening located at the top corner. The whole legumes fan out at the bottom of the screen and can be subdivided according to size and density. A portion of the agitated whole legumes that arrives at the lower portion of the screen may then be removed, thus removing stones and other debris. In an embodiment, air is forced through the screen to agitate the whole legumes, suitable to move the components of the whole legumes and to facilitate movement of less-dense components to a lower portion of the tilted screen. In an embodiment, washing and destoning further includes rinsing the whole legumes, such as during the destoning process.

In an embodiment, washing and destoning bulk whole legume and/or selecting whole legumes includes metering and comingling the whole legumes with a stream of water, then passing the stream of water containing the whole legumes over a series of riffles where the heavier stones and sand settle down to the bottom of the riffles as the lighter whole legumes with the water pass over the top of the riffles and onto a perforated belt where the whole legumes are separated from the wash water.

Process block 103 may be followed by process block 105, which includes conditioning the washed and destoned whole legumes. In an embodiment, conditioning the washed and destoned whole legumes includes contacting the washed and destoned legumes with conditioning water under conditions and for a time sufficient to hydrate the washed and destoned legumes. By saturating the whole legumes, cooking the whole legumes may occur more quickly, as heat may be more easily transferred by water in the saturated whole legumes than if the whole legumes were, for example, dry. Further, the hydrated, conditioned legumes may use less water to cook than if cooking dry whole legumes.

In an embodiment, conditioning the washed and destoned legumes includes contacting the washed and destoned legumes with conditioning water having a temperature of about 90° Fahrenheit for about 16 hours at atmospheric pressure. In an embodiment, conditioning the washed and destoned legumes includes contacting the washed and destoned legumes with conditioning water having a temperature of about 70° Fahrenheit for about 18 hours at atmospheric pressure. In an embodiment, conditioning the washed and destoned legumes includes contacting the washed and destoned legumes with conditioning water having a temperature of about 70° Fahrenheit for about 4-12 hours, such as for about 6 hours, at atmospheric pressure. In an embodiment, the conditioned legumes have an internal moisture content in a range of about 40% to about 60%.

In an embodiment, the conditioned legumes have a moisture content in a range of about 52 wt % to about 54 wt %.

In an embodiment, conditioning the washed and destoned legumes further comprises contacting the washed and destoned legumes with an additive selected from the group consisting of a processing aid, a flavor, a dye, and combinations thereof. Such a processing aid may be suitable to provide a desired characteristic of a cooked whole legume. In that regard and in an embodiment, the processing aid is selected from the group consisting of calcium chloride, sodium chloride, iron sulfate, and combinations thereof. Calcium chloride may delay softening of a whole legume as it cooks. For whole legumes that cook quickly, calcium chloride may be added to delay cooking processes, such as softening. Salts, such as sodium chloride may precipitate sugars in legumes that are generally indigestible. Further, an additive to change a pH of the conditioned whole legumes may be added, as pH conditions can affect protein-protein bonding and gelation of carbohydrates in a legume.

Process block 105 may be followed by process block 107, which includes cooking the washed and destoned whole legumes to provide cooked legumes. Such cooking can include the application of heat, pressure, moisture, and combinations thereof to the whole legumes for a time sufficient to provide whole legumes having desired organoleptic qualities.

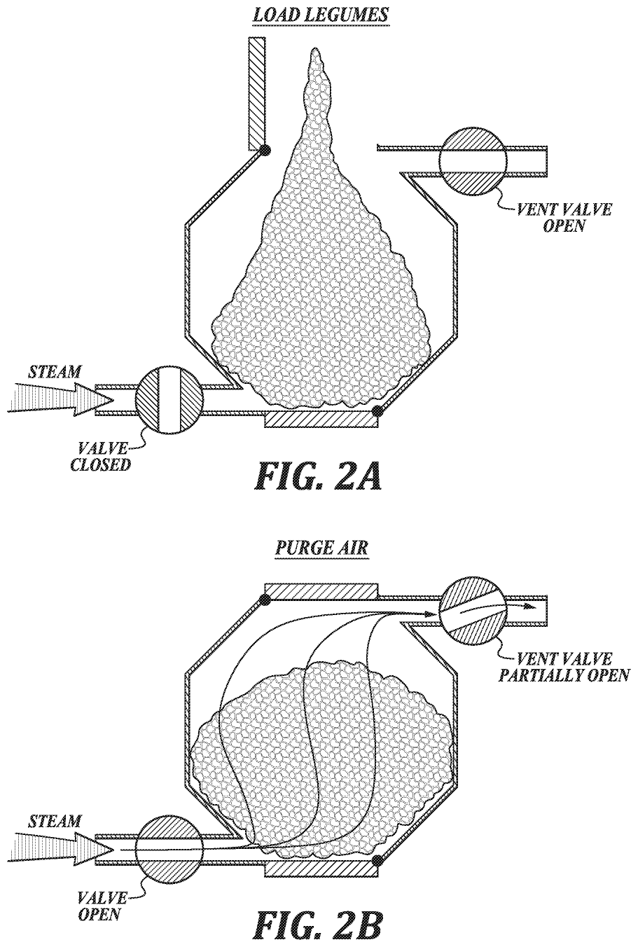

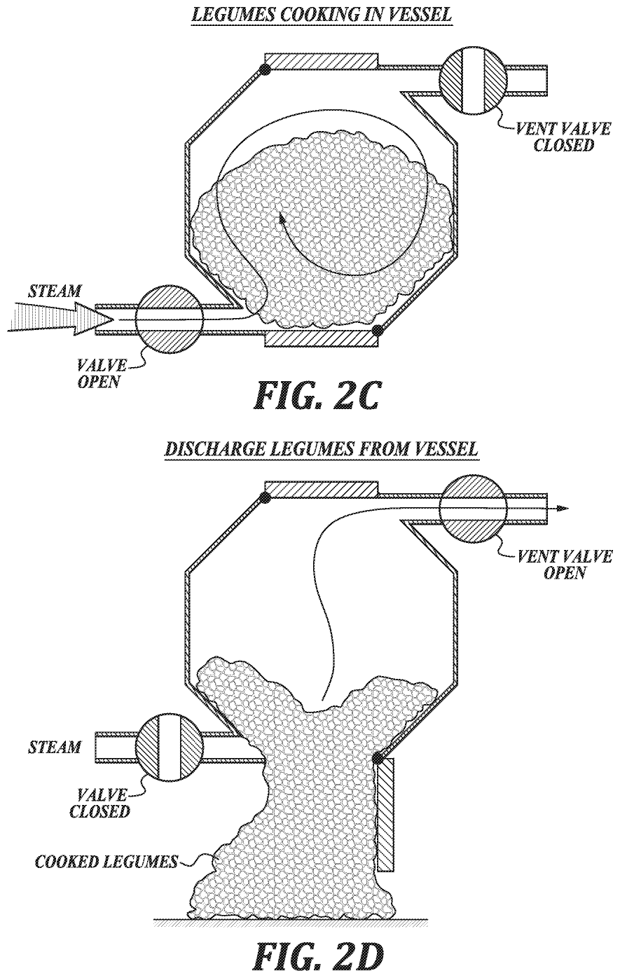

In an embodiment, cooking the whole legumes includes cooking with live steam, such as is described further herein in EXAMPLE 1 and with respect to FIGS. 2A-2D. As described, such cooking can include purging a cooking vessel holding whole legumes of air with steam; exposing the oxygen-purged cooking vessel holding the whole legumes to steam under conditions and for a time sufficient to cooking the whole legumes; and releasing the steam and the cooked legumes from the cooking vessel. As shown in FIG. 2B, purging the cooking vessel of oxygen can include opening a steam valve and partially opening a vent valve of the cooking vessel to pass steam through the cooking vessel.

As above, in an embodiment, cooking the washed and destoned whole legumes comprises contacting the washed and destoned legumes with saturated steam for a time and at a temperature sufficient to cook the washed and destoned legumes. In an embodiment, contacting the washed and destoned legumes with saturated steam is performed at a pressure in a range of about 1 pound per square inch gauge (p.s.i.g.) to about 20 p.s.i.g. In an embodiment, contacting the washed and destoned legumes with saturated steam is performed at a pressure in a range of about 1 p.s.i.g. to about 60 p.s.i.g., such as at about 40 p.s.i.g. In an embodiment, contacting the washed and destoned legumes with saturated steam is performed at a pressure in a range of about 8 p.s.i.g. to about 12 p.s.i.g.

In an embodiment, oxygen is purged from a cooking vessel prior to or as cooking begins. See FIG. 2B. Oxygen in the cooking vessel can produce a false measured pressure and/or temperature reading, leading to unintended cooking conditions.

In an embodiment, a mass:mass ratio of cooking water, such as in the form of water vapor, to washed and destoned whole legumes is in a range of about 0.05 to about 0.15. In an embodiment, a mass:mass ratio of cooking water, such as in the form of water vapor, to washed and destoned whole legumes is about 0.10, such as about 0.09.

In an embodiment, cooking further includes introducing an additive to the cooking vessel with the washed and destoned legumes, wherein the additive is selected from the group consisting of an herb, a spice, salt, a vegetable, and combinations thereof. Such additives may impart additional flavor and/or texture to the cooked whole legumes.

Process block 107 may be followed by process block 109, which includes grinding a portion of the cooked legumes to provide ground cooked legumes. A portion of such ground legumes have an average size smaller than the cooked legumes. In an embodiment, grinding a portion of the cooked legumes comprises grinding the portion of the cooked lentils between two plates wherein at least one of the two plates rotates relative to another plate of the two plates. In an embodiment, process block 109 is optional.

Such ground legumes, when combined with whole cooked legumes provide different texture to the whole-legume food products. In an embodiment, an average size and/or a size distribution of the ground legumes provides a texture different than a texture of whole cooked legumes. In this regard, ground legumes can be combined with whole cooked legumes to tune a texture of a whole-legume food product. In an embodiment, at least 80% of the ground cooked legumes have a largest dimension smaller than 1/16^{th} of an inch. In an embodiment, a largest dimension of the ground cooked legumes is less than 15/64^{th} of an inch. In an embodiment, the ground cooked legumes have a particle size distribution wherein about 47.5% of the ground legumes have a largest dimension smaller than 0.055 inches; and about 15% of the ground legumes have a largest dimension in a range of about 0.055 inches to about 0.079 inches; about 29.5% of the ground legumes have a largest dimension in a range of about 0.079 inches to about 0.094 inches; and about 8% of the ground legumes have a largest dimension in a range of about 0.094 inches to about 0.187 inches.

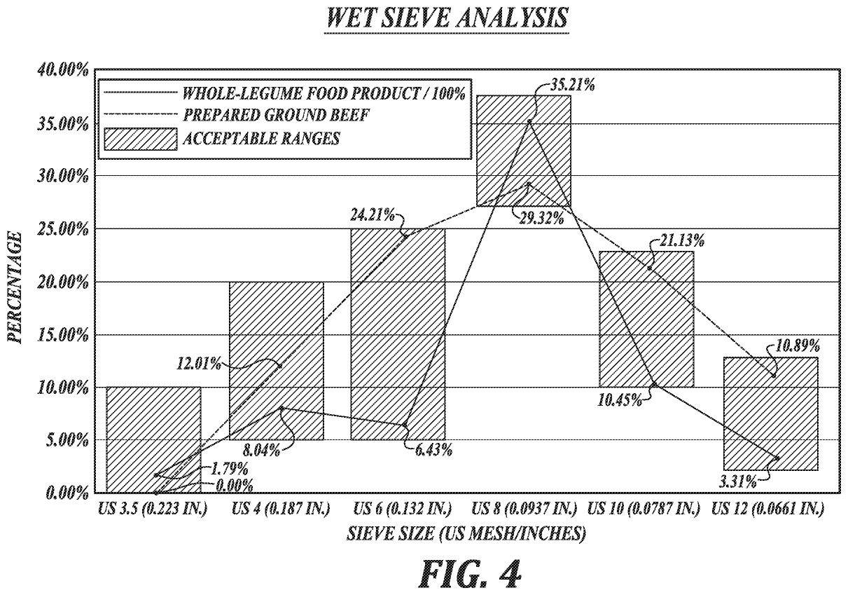

FIG. 4 graphically illustrates a comparison of percentage of ground proteins vs. sieve size for prepared ground beef and a whole-legume food product, in accordance with an embodiment of the present disclosure. As shown and as described further herein with respect to EXAMPLE 7, the whole-legume food product of the present has a particle size distribution similar that of prepared ground beef. Such similarities between the particle size distributions provide organoleptic qualities, such as texture, mimicking that of ground beef, making the whole-legume food product of the present disclosure a meat analog.

As described further herein with respect to EXAMPLE 7, the particle size distribution of the whole-legume food product affects certain organoleptic qualities of the whole-legume food product, such as when it is reconstituted. For example, firmness of the whole-legume food product can be modulated by changing the particle size distribution of the whole-legume food product. In this regard, a whole-legume food product having a particle size distribution with a relatively large proportion of smaller particles will be generally less firm than a whole-legume food product having a particle size distribution with a greater proportion of larger particles. Accordingly, the particle size distribution can be shifted or otherwise changed to arrive at a desired, for example, firmness, such as a firmness analogous to a cooked meat product.

In an embodiment, a weight percent of whole cooked legumes of the combined cooked legumes is in a range of about 1 wt % to about 5 wt %. In an embodiment, a weight percent of whole cooked legumes of the combined cooked legumes is in a range of about 0.5 wt % to about 10 wt %. In an embodiment, a weight percent of whole cooked legumes of the combined cooked legumes is in a range of about 2 wt % to about 5 wt %. One of skill in the art will understand what proportion of a whole-legume food product should include whole cooked legumes compared to, for example, ground legumes based upon a desired texture or other organoleptic characteristic.

In an embodiment, the cooked legumes are void of or substantially void of lectins. In this regard, the cooked legumes are safe to eat when, for example, the cooked legume is soft enough to be squashed between a forefinger and a thumb without substantial resistance. In an embodiment, the whole-legume food products of the present disclosure are void of or substantially void of lectins. Lectins can irritate or inflame the digestive system when consumed. Accordingly, by reducing or eliminating their content, such as by performing the methods of the present disclosure, consumers of the whole-legume food products of the present disclosure are less likely to experience inflamed or irritated digestive systems than if they had consumed food products prepared by methods that did not degrade lectins occurring in legumes.

Process block 109 can be followed by process block 111, which includes forming, with a former, the cooked legumes into a shape. In an embodiment, process block 111 is optional. Forming can include mixing the cooked whole legumes as well as pressing the cooked whole legumes into a shape. Such a shape may be suitable to provide organoleptic qualities, such as texture and appearance, resembling a cooked meat product, particularly, for example, when reconstituted. In an embodiment, the shape is selected from the group consisting of a flake, a pellet, a cube, and a patty. Further, by forming the cooked whole legumes, such as by mixing, the cooked whole legumes may have a greater consistency in terms of, for example, a color of the cooked whole legumes and texture of the cooked whole legumes.

Process block 111 can be followed by process block 113, which includes drying the cooked legumes to provide dried cooked legumes. By drying the cooked legumes, weight and density of the cooked legumes is reduced, thus reducing shipping costs. Further, spoilage is reduced and shelf life of the dried cooked legumes is extended relative to cooked wet legumes due to the reduced moisture content of the dried cooked whole legumes. In this regard, the dried cooked legumes do not require refrigeration or freezing as a wet cooked legume might. Additionally, the dried cooked legumes may be packaged into a variety of packages beyond cans, for example, such as those used to contain wet, cooked legumes. Cans can be dented or otherwise deformed rendering them unsuitable for sale, whereas flexible containers, such as bags or pouches, suitable for carrying the dried cooked legumes do not generally dent. Further, such flexible containers, including pouches, are easy to open and discard compared to, for example, cans. In this regard, the whole-legume food products of the present disclosure are easier to transport and access and more reliable to sell than, for example, wet, cooked legumes contained in metal cans.

Such dried cooked legumes are suitable to be reconstituted, such as by an end user, by, for example, soaking in hot water for a time sufficient to soften the dried cooked legumes to a desired consistency.

Such drying may be performed by any suitable techniques to remove water from the cooked legumes. Such methods include, for example, through-the-bed hot air drying, heating, freeze drying, drying under vacuum, and the like. In an embodiment, the dried cooked legumes have a water content in a range of about 3 wt % to about 9 wt %. In some embodiments, a water content of over about 9 wt % may result in spoilage of a finished whole-legume food product. In some embodiments, a water content of less than about 3 wt % may result in oxidization of the finished whole-legume food product and/or a shortened shelf life. In an embodiment, the dried cooked legumes have a water content in a range of about 6 wt % to about 7 wt %.

Process block 113 can be followed by process block 115, which includes selecting a portion of the dried cooked legumes having a size in a predetermined size range. In an embodiment, process block 115 is optional. A size, size range, and/or size distribution of dried cooked legumes can contribute to organoleptic qualities of the dried cooked legumes, as well as reconstituted whole-legume food products. In an embodiment, the predetermined size is about ¾″.

In an embodiment, selecting the portion of the dried cooked legumes having a size in a predetermined size range includes pressing a portion of the dried cooked legumes through a screen or sieve defining apertures of a particular size or size range, such as with a beater bar. In an embodiment, selecting the portion of the dried cooked legumes having a size in a predetermined size range includes placing the dried cooked legumes between two plates including facing grooved surfaces, wherein at least one of the two plates rotates. Such plates are suitable to provide sized dried cooked legumes having a distribution of sizes. Such a distribution of sizes is suitable to provide the appearance of some meat products, such as ground cooked meat.

Process block 115 can be followed by process block 117, which includes enrobing the dried cooked legumes with a flavoring mixture to provide enrobed legumes. In an embodiment, the flavoring mixture comprises an oil and flavorings dissolved or distributed in the oil. By enrobing the dried cooked legumes with the flavoring mixture, the enrobed legumes include flavors suitable for particular end uses. For example, the flavor mixture may include herbs, spices, and the like, suitable for particular dishes or cuisines. In an embodiment, the flavor mixture includes herbs, spices, and the like conventionally used in spiced ground taco meat. In an embodiment, the dried cooked legumes with a flavoring mixture that includes an oil also alters and improves mouthfeel and other organoleptic qualities.

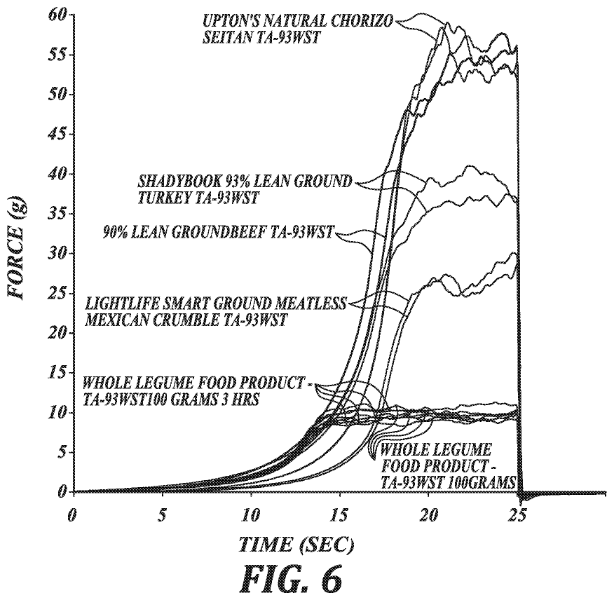

Additionally, by enrobing the dried and cooked legumes with an oil, evaporation of water, such as water added to a dried and cooked legume during reconstitution, is limited or reduced. Without wishing to be bound by theory, it is believed that the oil enrobing the dried and cooked legumes forms a barrier around the dried and cooked legumes, which limits evaporation therefrom. By limiting evaporation, the whole-legume food products of the present disclosure have a longer period of time during which the whole-legume food product may be served after reconstitution, while retaining a desired texture profile, as discussed further herein with respect to EXAMPLE 9 and FIG. 6.

In an embodiment, enrobing the dried cooked legumes includes coating the dried cooked legumes with the flavoring mixture, such as by mixing the dried cooked legumes with the flavoring mixture.

Process block 117 can be followed by process block 119, which includes placing the enrobed legumes in a package. As discussed further herein with respect to drying the cooked legumes, the enrobed legumes may be placed in a package that is soft-sided or otherwise malleable, at least in part, because the enrobed legumes include the dried cooked legumes enrobed in a flavoring mixture. While soft-sided packages are discussed herein, the enrobed legumes are also suitable to be placed in other packages, such as cans, jars, bins, and the like. In an embodiment, the package is configured to hold an amount of the enrobed legumes suitable for a single serving. In an embodiment, the package is configured to hold an amount of the enrobed legumes suitable for multiple servings. In an embodiment, the package is configured to hold an amount of the enrobed legumes suitable for commercial kitchens providing multiple servings.

In an embodiment, the package includes instructions for preparation of a reconstituted whole-legume food product using the enrobed legumes. Such instructions can include directions to contact the enrobed legumes with water at a temperature and for a time suitable to provide a reconstituted whole-legume food product. In an embodiment, the instructions include directions to contact the enrobed legumes with a specified amount of water at a temperature and for a time suitable to provide a reconstituted whole-legume food product. In an embodiment, an amount of water specified by the directions for reconstitution is less than an amount of water the enrobed legumes are configured to absorb. In so doing, the reconstituted whole-legume food product retains textural characteristics more closely resembling, for example, ground meat.

Such instructions can include directions for preparing a reconstituted whole-legume food product using a microwave, a stove top, a steam tray, an oven, or combinations thereof as discussed further herein with respect to the whole-legume food products of the present disclosure.

Process block 119 can be followed by process block 121, which includes reconstituting the enrobed legumes. In an embodiment, process block 121 is optional. In an embodiment, reconstituting the enrobed legumes comprises contacting the enrobed legumes with water at a temperature and for a time suitable to provide a reconstituted whole-legume food product. In an embodiment, reconstituting the enrobed legumes is performed using a stove top, a microwave, a steam table, an oven, and combinations thereof. In an embodiment, reconstituting the enrobed legumes includes placing 5 ounces of the enrobed legumes with 1 cup of water in a microwave and heating the enrobed legumes and water in the microwave for 6 minutes. In an embodiment, reconstituting the enrobed lentils includes: contacting 5 ounces of the enrobed legumes with 1 cup of boiling water; and heating the enrobed legumes and the water until the water is absorbed into the enrobed legumes. In an embodiment, reconstituting the enrobed legumes includes: contacting 40 ounces of the enrobed legumes with 2 quarts of water in a steam tray; leveling the enrobed legumes in the steam tray; placing a lid on the tray; and heating the enrobed legumes and the water in the steam tray with a steam table until the enrobed legumes reach a temperature of about 172° Fahrenheit. In an embodiment, reconstituting the enrobed legumes includes: contacting 40 ounces of the enrobed legumes with 2 quarts of water in a steam tray; leveling the enrobed legumes in the steam tray; placing a lid on the tray; and heating the enrobed legumes in the steam tray in an oven at about 325° Fahrenheit until the enrobed legumes reach a temperature of about 172° Fahrenheit.

### Whole-Legume Food Product

In another aspect, the present disclosure provides a whole-legume food product comprising dried cooked whole legumes; and a flavoring mixture enrobing the dried cooked whole legumes. In an embodiment, the whole-legume food product is made according to the methods described herein. As discussed further herein, in an embodiment, the whole-legume food product includes dried cooked whole legumes and portions of dried cooked whole legumes. In an embodiment, such portions of dried cooked whole legumes are distinct from concentrates, isolates, fractionates, and the like, which are based on or derived from a legume or other food product. In this regard, such concentrates, isolates, fractionates, and the like may be based upon a legume, but have been separated from their natural surrounding components. By contrast, the portions of dried cooked whole legumes of the present disclosure may be based upon ground cooked whole legumes in which whole legumes are simply broken into smaller pieces.

In an embodiment, the whole-legume food product comprises dried cooked whole lentils. In an embodiment, dried cooked whole lentils are selected from the group consisting of French green lentils, petite Estoria lentils, Spanish Pardina lentils, marrow lentils, petite Castillo lentils, lenticche Verdi lentils, black beluga lentils, Richlea lentils, Red Chief lentils, Brewer lentils, Crimson lentils, Large Green lentils, Eston lentils, and Puy lentils. In an embodiment, dried cooked whole lentils are selected from the group consisting of Brewer, Cedar, Crimson, Essex, Eston, French Green, Greenland, Impact, Merrit, Meteor, Morena, Pardina, Pennell, Redberry, Richlea, Rivland, Shasta, Vantage, and combinations thereof. In an embodiment, the dried cooked whole lentil is the Madeline variety of the French Green lentil. In an embodiment, the dried cooked whole lentil is a Canadian marble variety of lentil.

In an embodiment, the whole-legume food product is or is suitable to produce a meat analog. In that regard, the whole-legume food product is or is suitable to produce, such as by reconstitution, a product having organoleptic qualities analogous to a cooked meat product. As above, the whole-legume food products described herein may be reconstituted, such as soaking in boiling water, to provide a reconstituted whole-legume food product. Such a reconstituted whole-legume food product may have qualities, such as texture, appearance, flavor, and the like, analogous to such qualities of cooked meat food products. Such cooked meat food products can include, for example, ground cooked meat.

As above, the whole-legume food products of the present disclosure can be meat analogs. These whole-legume food products include many advantageous characteristics, as described further herein, and as summarized immediately below in TABLE 1. These advantageous characteristics of the whole-legume food products of the present disclosure are in contrast to analogous characteristics of other conventional meat analogs, also summarized in TABLE 1.

TABLE 1
Characteristics of Whole-Legume Food Products, according to an embodiment
of the present disclosure, and conventional meat analogs.

| | Whole-Legume | Impossible Burger | |
|---|---|---|---|
| Characteristic | Food Product | Crumbles | Beyond Meat Crumbles |
| Dry shelf Stable | Yes | No | No |
| product | | | |
| Shipping | Lower | Higher transportation cost/ | Higher transportation |
| transportation | transportation cost/ | refrigeration is required | cost/refrigeration is |
| costs | no refrigeration | during transport | required during transport |
| | required during | | |
| | transport | | |
| Labor cost/ | Add table water | Needs cooking, addition of | Needs cooking, addition |
| production time | | seasoning | of seasoning |
| efficiency | | | |
| Yield | 5-pound dry yields | Moisture loss during | |
| | 13 pounds of wet | cooking | |
| | product | | |
| Ingredients: | Whole lentils, Non- | Water, Soy Protein | Water, Pea Protein |
| | GMO oil, | Concentrate, Coconut Oil, | Isolate, Canola and |
| | Seasonings, Yeast | Sunflower Oil, Natural | Sunflower Oil, Spice, |
| | Source of whole | Flavors, 2% or less of: | Rice Flour, Yeast Extract, |
| | intact legume | Potato Protein, | Tomato Powder, |
| | kernel, no isolate or | Methylcellulose, Yeast | Maltodextrin, Sugar, |
| | concentrates are | Extract, Cultured | Potassium Bicarbonate, |
| | used. | Dextrose, Food Starch | Potassium Chloride, |
| | | Modified, Soy | Caramel Color, Lemon |
| | | Leghemoglobin, Salt, Soy | Juice Concentrate, Citric |
| | | Protein Isolate, Mixed | Acid, Salt, Calcium |
| | | Tocopherols (Vitamin E), | Sulfate, Onion Extract, |
| | | Zinc Gluconate, Thiamine | Natural Flavor, Garlic |
| | | Hydrochloride (Vitamin | Extract. |
| | | B1), Sodium Ascorbate | |
| | | (Vitamin C), Niacin, | |
| | | Pyridoxine Hydrochloride | |
| | | (Vitamin B6), Riboflavin | |
| | | (Vitamin B2), Vitamin | |
| | | B12. | |
| | | Contains: Soy | |
| Nutrient benefit | Source of slow | Soy protein concentrate | pea protein isolate does |
| for human health | carbs, protein, iron, | does not offer the | not offer the nutritional |
| | minerals and other | nutritional benefits of | benefits of eating |
| | antioxidants. | eating consuming whole | consuming whole |
| | During the | soybean as it has gone | soybean as it has gone |
| | processing fibers | through major processing | through major processing |
| | and other nutrient | similar to refining of oil or | similar to refining of oil |
| | loss is minimized | grain. | or grain |
| | making the | | |
| | nutrients | | |
| | bioavailable to | | |
| | promote digestive | | |
| | health. | | |
| | Product contains | | |
| | diverse variety of | | |
| | fibers including | | |
| | prebiotic fiber, RS | | |
| | (Resistance Starch) | | |
| | which plays an | | |
| | important role in | | |
| | colon and gut | | |
| | health. Healthy gut | | |
| | plays important | | |
| | role in prevention | | |
| | and treatment of | | |
| | various chronic | | |
| | disease conditions | | |
| | specifically | | |
| | diabetes, weight | | |
| | management, | | |
| | hypertension, | | |
| | mental health | | |
| | among others. | | |
| More than 5 | Yes (soluble, non- | No | No |
| grams of fiber per | soluble, Prebiotic) | | |
| serving | | | |
| Fat | No sat fat, trans fat | Yes, contains sat fat | No sat fat, trans fat |
| Source of iron | Yes | Yes | Yes |
| Potential spoilage | | | |
| issues such as | | | |
| bacterial growth | | | |
| during | | | |
| transportation, | | | |
| storage | | | |
| Minimally | Yes | No | No |
| processed leading | | | |
| to better carbon | | | |
| foot print | | | |

As above, whole legumes provide a number of health benefits. Such health benefits and nutritional value may be over and above analogous benefits provided by meat, such as ground beef. As discussed further herein, the whole-legume food product is suitable to be used as a meat analog, replacer, fortifier, extender, and the like. In this regard, the whole-legume food product of the present disclosure, such as those including lentils, provides a number of health and nutritional benefits over and above those provided by meat.

Lentils provide a number of macronutrients. For example, a ½-cup serving of cooked lentils, which is about 100 grams, contains 116 calories, 9 grams of protein, 0.4 gram of fat and 20 grams of carbohydrate, including 8 grams of fiber. A smaller 3-ounce serving of pan-browned 85-percent-lean ground beef, which is about 85 grams, contains 218 calories, 24 grams of protein and 15 grams of fat, including 5 grams of saturated fat. The lentils provide 32 percent of the daily value for fiber, which helps you feel full and lowers your risk for heart disease, and only trace amounts of fat. The ground beef, by contrast, provides 23 percent of the DV for total fat and 25 percent of the DV for saturated fat and no fiber.

Lentils provide a number of vitamins. Each ½-cup serving of lentils provides you with 181 micrograms of folate, or 45 percent of the DV, compared to 8 micrograms, or 2 percent of the DV, in ground beef. Lentils are also higher in thiamine, providing 11 percent of the DV per serving compared to 2 percent in each serving of ground beef.

Lentils also provide more of some minerals per serving than ground beef. Each ½-cup serving provides 3.3 milligrams of iron, or 19 percent of the DV; 36 milligrams of magnesium, or 9 percent of the DV; 369 milligrams of potassium, or 11 percent of the DV. Ground beef provides slightly less of these minerals, with each serving containing 2.5 milligrams of iron, 21 milligrams of magnesium and 346 milligrams of potassium. However, it contains more phosphorus and zinc. Lentils have much less sodium, with only 2 milligrams per serving compared to the 76 milligrams found in each serving of ground beef.

Eating lentils and other pulses regularly may help lower your risk for cancer, heart disease and diabetes, according to North Dakota State University. Consuming red meat regularly, on the other hand, may increase your risk for dying of cancer or heart disease, according to a study published in the “Archives of Internal Medicine” in April 2012.

In an embodiment, the whole-legume food products of the present disclosure meet the criteria set forth by the USDA to be used as a Meat Alternative. In this regard, the whole-legume food products of the present disclosure have as a main ingredient a whole legume, such as a whole bean or whole lentil, in its natural form that has been cooked, canned, or roasted. In an embodiment, the whole-legume food products of the present disclosure qualify for a USDA application in school lunch and USDA distribution programs. Accordingly, the whole-legume food products of the present disclosure may be properly classified as a meat equivalent when served in an equivalent quantity in those programs.

In an embodiment, the flavoring mixture includes an oil and flavorings dissolved or distributed in the oil. In an embodiment, such flavorings can include herbs, spices, vegetables, and the like. In an embodiment, the flavoring mixture resembles or includes flavoring mixtures conventionally used to flavor cooked meat food products. In an embodiment, the flavoring mixture is a flavoring mixture for tacos. In an embodiment, such a whole-legume food product includes a blend of 7.263% of whole cooked and dried Madeline French Green Lentils, 65.367% ground lentils (for example as disclosed in Process Block 113), 13.61% Sunflower oil, 5.32% dry yeast, 3.32% Garlic powder, 2.62% Onion powder, 1.25% Cumin, 0.54% Red Pepper, 0.53% Salt and 0.18% Black Pepper.

In an embodiment, the flavoring mixture includes herb, spices, and the like conventionally used in various dishes such as; taquitos, taco salad, stuffed potatoes, stuffed chili poblano, stuffed bell peppers, stroganoff, spaghetti, soups, sloppy joes, shepherd's pie, scrambled eggs, rice dishes, nachos, meat loaf, meat pies, mac & cheese, lasagna, Korean beef bowl, Japanese beef croquettes, ground beef & mashed potatoes, ground beef pie, enchiladas, empanadas, egg omelets, dumplings, chorizo, chili beans, casseroles, cabbage rolls, burritos, beef stew, beef goulash, beef cornbread, and beef cannelloni.

In an embodiment, the whole-legume food product is a meat analog for cooked taco meat. In this regard, the whole-legume food product, particularly when reconstituted, has organoleptic qualities analogous to or overlapping with those of cooked ground meat. In some embodiments, ground meat approaches a slurry. In this regard, the reconstituted whole-legume food product of the present disclosure is in the form of a slurry having organoleptic characteristics of ground meat, particularly as the whole-legume food product has the particle size distributions described further herein. Further, the flavoring mixture can include herbs, spices, and the like conventionally used to flavor taco meat, such as flavorings selected from the group consisting of garlic, onion, salt, natural smoke flavor, cumin, red pepper, black pepper, paprika, and combinations thereof.

As discussed further herein with respect to the methods of the present disclosure, size and size distribution of the whole legumes of the whole-legume food product can contribute to a texture of the whole-legume food product. In an embodiment, the whole-legume food product includes intact whole legumes. In an embodiment, the whole-legume food product includes ground whole legumes, such as portions of whole legumes. In an embodiment, at least 80% of the ground whole legumes have a largest dimension smaller than 1/16^{th} of an inch. In an embodiment, a largest dimension of the ground whole legumes is less than 15/64^{th} of an inch.

In an embodiment, the ground whole legumes have a particle size distribution wherein greater than 0 w/w % to about 10 w/w % of the ground whole legumes have a largest dimension in a range of about 0.223 inches to about 0.187 inches. In an embodiment, the ground whole legumes have a particle size distribution wherein about 5 w/w % to about 20 w/w % of the ground whole legumes have a largest dimension in a range of about 0.187 inches to about 0.132 inches. In an embodiment, the ground whole legumes have a particle size distribution wherein about 5 w/w % to about 25 w/w % of the ground whole legumes have a largest dimension in a range of about 0.132 inches to about 0.0937 inches. In an embodiment, the ground whole legumes have a particle size distribution wherein about 27.5 w/w % to about 37.5 w/w % of the ground whole legumes have a largest dimension in a range of about 0.0937 inches to about 0.0787 inches. In an embodiment, the ground whole legumes have a particle size distribution wherein about 10 w/w % to about 22.5 w/w % of the ground whole legumes have a largest dimension in a range of about 0.0787 inches to about 0.0661 inches. In an embodiment, the ground whole legumes have a particle size distribution wherein about 2.5 w/w % to about 12.5 w/w % of the ground whole legumes have a largest dimension smaller than about 0.0661 inches.

In an embodiment, the ground whole legumes have a particle size distribution wherein about 47.5% of the ground whole legumes have a largest dimension smaller than 0.055 inches; and about 15% of the ground whole legumes have a largest dimension in a range of about 0.055 inches to about 0.079 inches; about 29.5% of the ground whole legumes have a largest dimension in a range of about 0.079 inches to about 0.094 inches; and about 8% of the ground whole legumes have a largest dimension in a range of about 0.094 inches to about 0.187 inches.

As discussed further herein with respect to FIG. 4 and EXAMPLE 7, such particle size distributions provide the whole-legume food products of the present disclosure with organoleptic qualities, such as textural and visual characteristics, analogous to ground meat, such as prepared ground beef. In this regard, the whole-legume food products of the present disclosure are meat analogs.

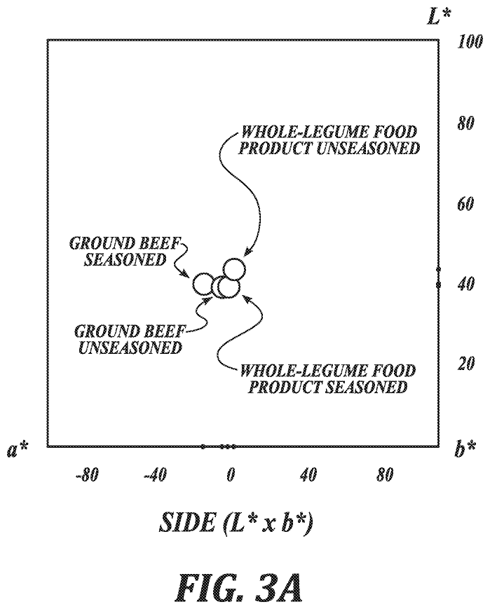

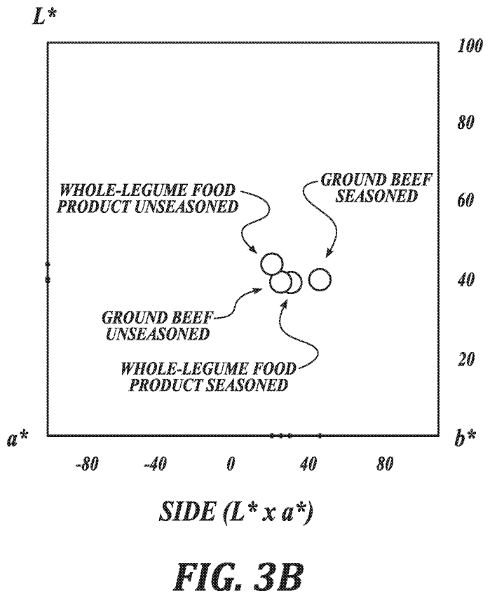

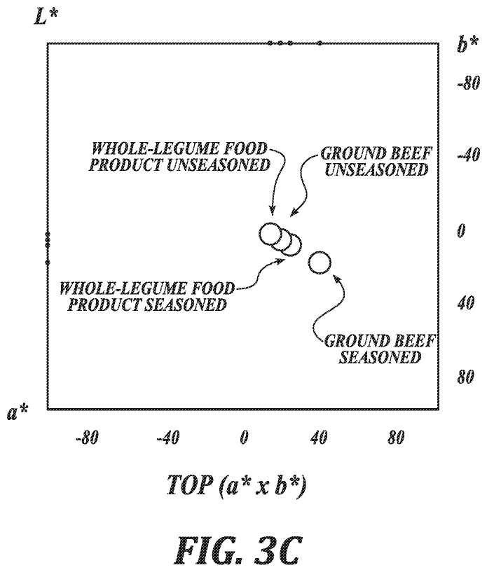

In an embodiment, the whole-legume food products of the present disclosure have color characteristics similar to that of prepared ground meat. As shown in FIGS. 3A-3C, the whole-legume food products of the present disclosure have a color in a CIELAB color space analogous to prepared ground beef, whether seasoned or unseasoned. In this regard, the whole-legume food products of the present disclosure have yet another metric similar to that of ground meat.

In an embodiment, the whole-legume food product has an L* value in a CIELAB color space in a range of about 35 to about 45. In an embodiment, the whole-legume food product has an L* value in a CIELAB color space in a range of about 36 to about 44. In an embodiment, the whole-legume food product has an L* value in a CIELAB color space in a range of about 38 to about 44. In an embodiment, the whole-legume food product has an L* value in a CIELAB color space of about 38, such as where the whole-legume food product is enrobed in a flavoring mixture as described elsewhere herein. In an embodiment, the whole-legume food product has an L* value in a CIELAB color space of about 44, such as where the whole-legume food product is unseasoned.

In an embodiment, the whole-legume food product has an a* value in a CIELAB color space in a range of about 1 to about 15. In an embodiment, the whole-legume food product has an a* value in a CIELAB color space in a range of about 3 to about 12. In an embodiment, the whole-legume food product has an a* value in a CIELAB color space in a range of about 4 to about 11. In an embodiment, the whole-legume food product has an a* value in a CIELAB color space of about 11, such as where the whole-legume food product is enrobed in a flavoring mixture as described elsewhere herein. In an embodiment, the whole-legume food product has an a* value in a CIELAB color space of about 5, such as where the whole-legume food product is unseasoned.

In an embodiment, the whole-legume food product has a b* value in a CIELAB color space in a range of about 10 to about 30. In an embodiment, the whole-legume food product has a b* value in a CIELAB color space in a range of about 12 to about 28. In an embodiment, the whole-legume food product has a b* value in a CIELAB color space in a range of about 14 to about 25. In an embodiment, the whole-legume food product has a b* value in a CIELAB color space of about 24, such as where the whole-legume food product is enrobed in a flavoring mixture as described elsewhere herein. In an embodiment, the whole-legume food product has a b* value in a CIELAB color space of about 15, such as where the whole-legume food product is unseasoned.

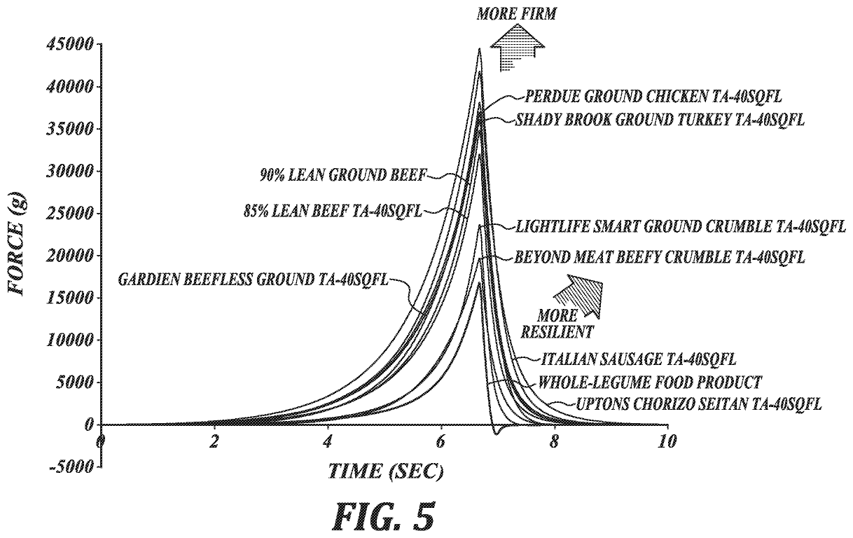

In an embodiment, the whole-legume food products of the present disclosure have a texture characteristic mimicking that of or similar to a ground meat, such as cooked ground meat. Accordingly, in an embodiment, the whole-legume food products of the present disclosure have a resilience, firmness, and instant springback, such as a resilience, firmness, and instant springback measured using a TA-040SQFL-G test set-up from Texture Technologies (Hamilton, Mass.), similar to analogous characteristics of ground meat. As discussed further herein with respect to EXAMPLES 8 and 9 and shown in FIGS. 5 and 6, the whole-legume food products of the present disclosure have one or more of a resilience, firmness, and instant springback similar to that of prepared ground meat.

In an embodiment, the whole-legume food product has an absolute peak compression force in a range of about 15 kg to about 40 kg, as measured with Texture Technologies TA-040SQFL-G plate. In an embodiment, the whole-legume food product has an absolute peak compression force in a range of about 15 kg to about 30 kg, as measured with Texture Technologies TA-040SQFL-G plate. In an embodiment, the whole-legume food product has an absolute peak compression force in a range of about 15 kg to about 20 kg, as measured with Texture Technologies TA-040SQFL-G plate. In an embodiment, the whole-legume food product has an absolute peak compression force in a range of about 15 kg to about 18 kg, as measured with Texture Technologies TA-040SQFL-G plate.

In an embodiment, the whole-legume food product has a resilience in a range of about 10% to about 35%, as measured with Texture Technologies TA-040SQFL-G plate. In an embodiment, the whole-legume food product has a resilience in a range of about 15% to about 25%, as measured with Texture Technologies TA-040SQFL-G plate. In an embodiment, the whole-legume food product has a resilience in a range of about 15% to about 20%, as measured with Texture Technologies TA-040SQFL-G plate.

In an embodiment, the whole-legume food product has an instant springback in a range of about 20% to about 55%, as measured with Texture Technologies TA-040SQFL-G plate. In an embodiment, the whole-legume food product has an instant springback in a range of about 25% to about 50%, as measured with Texture Technologies TA-040SQFL-G plate. In an embodiment, the whole-legume food product has an instant springback in a range of about 25% to about 35%, as measured with Texture Technologies TA-040SQFL-G plate.

In an embodiment, the whole-legume food product has an absolute peak compression force of in a range of about 10 kg to about 40 kg as measured with a Texture Technologies TA-93WST Wire Screen Forward Extrusion rig. In an embodiment, the whole-legume food product has an absolute peak compression force of in a range of about 10 kg to about 30 kg as measured with a Texture Technologies TA-93WST Wire Screen Forward Extrusion rig. In an embodiment, the whole-legume food product has an absolute peak compression force of in a range of about 10 kg to about 20 kg as measured with a Texture Technologies TA-93WST Wire Screen Forward Extrusion rig.

In an embodiment, the whole-legume food product includes intact whole legumes and ground whole legumes. A proportion of the intact whole legumes to the ground whole legumes can be determined based on desired textural and other characteristics of a desired whole-legume food product and reconstituted whole-legume food product derived therefrom.

In an embodiment, the whole-legume food product has a shape resembling ground meat. In an embodiment, the whole-legume food product has shape other than ground meat, such a shape selected from the group consisting of a flake, a pellet, a cube, and a patty.

In an embodiment, the whole-legume food product has a water content suitable for a shipping and storage, as described further herein with respect to the methods of the present disclosure. In an embodiment, the whole-legume food product has a water content in a range of about 3 wt % to about 9 wt %. In an embodiment, the whole-legume food product has a water content in a range of about 6 wt % to about 7 wt %.

In an embodiment, the dried cooked whole legumes include dried cooked lentils. In an embodiment, whole lentils are selected from the group consisting of French green lentils, petite Estoria lentils, Spanish Pardina lentils, marrow lentils, petite Castillo lentils, lenticche Verdi lentils, black beluga lentils, Richlea lentils, Red Chief lentils, Brewer lentils, Crimson lentils, Large Green lentils, Eston lentils, and Puy lentils. In an embodiment, the whole lentil is the Madeline variety of the French Green lentil. In an embodiment, the whole lentil in a Canadian marble variety of lentil.

In an embodiment, the dried cooked whole legumes include whole legumes have a high ratio of cotyledon relative to other portions of the whole legume. The cotyledon, or seed leaf, is generally fibrous and, thus, provides structure to aid in the texture or mouth feel of the whole-legume food product. Varieties of whole legumes having such a relatively high ratio of cotyledon to other portions of the whole legume include Madeline and Peridot lentils.

In an embodiment, the whole-legume food product includes yeast or yeast extract. Such yeast or yeast extract can add to the flavor of the whole-legume food product. In this regard, the yeast or yeast extract may be part of the flavoring mixture. In an embodiment, the yeast or yeast extract contribute to the umami of the whole-legume food product.

In an embodiment, the whole-legume food product comprises a gum, such as a high-molecular-weight polysaccharide, and/or a modified starch. In an embodiment, such a gum or modified starch is hygroscopic and configured to absorb or otherwise take on moisture. In an embodiment, the whole-legume food product comprising a gum and/or a modified starch has a higher springback or coefficient of restitution compared to an analogous whole-legume food product not including a gum or modified starch. Likewise, the gum or modified starch is configured to hold together particles of the whole-legume food product, thereby providing the visual appearance of cooked ground meat in which particles of the cooked ground meat are analogously held together by rendered fat, proteins, and the like.

In an embodiment, the whole-legume food product is configured to absorb oil, such as fat, particularly rendered fat, from meat. In this regard, the whole-legume food product is suitable for use as a meat extender or fortifier, wherein the whole-legume food product is configured to absorb fat from cooked meat, thereby retaining it within the whole-legume food product. Accordingly, in an embodiment, the whole-legume food product further comprises a meat product, such as ground cooked meat. The whole-legume food product is in contrast to other meat extenders or fortifiers, such as textured vegetable protein, which does not or does not substantially absorb oils. Rather, oils, such as rendered meat fats, tend to adsorb onto surfaces of such meat extenders or fortifiers. Such surface-adsorbed oils are prone to being rinsed or otherwise removed from the surface of the, for example, textured vegetable protein, thereby losing the caloric and nutritional value of the fats.

In an embodiment, the whole-legume food product is configured to absorb oil in a range of about 20 w/w % to about 40 w/w %. In an embodiment, the whole-legume food product is configured to absorb about 21 w/w % oil. This is in contrast to textured vegetable protein, which adsorbs on its surface or otherwise retains less than about 12% w/w.

In addition to absorbing oil, the whole-legume food product is a meat fortifier in that it provides nutrients that are not generally provided by meat. Such additional nutrients include, for example, digestible and indigestible fiber, antioxidants, vitamins, and the like.

Additionally, in contrast to certain other meat analogs, extenders, and fortifiers, in certain embodiments, the whole-legume food products described herein are free or substantially free of soy, allergen free, and free of genetically modified organisms. As used herein, free or substantially free refers to a product that does not include a component or includes a component below levels detectable by current methods and instrumentation.

In an embodiment, the whole-legume food product is disposed in a package. As discussed further herein with respect to the methods of the present disclosure, such a package can include a can, a pouch, a sachet, a bag, and the like. In an embodiment, the package includes one or more generally soft sides.

In an embodiment, the package includes instructions for preparation of a reconstituted whole-legume food product. In an embodiment, the instructions for preparation include directions for performing reconstitution procedures, such as those described further herein with respect to the methods of the present disclosure. In an embodiment, the package includes instructions for preparation of a reconstituted whole-legume food product from the whole-legume food product. In an embodiment, the instructions include instructions to reconstitute the whole-legume food product including contacting the whole-legume food product with an amount of water less than an amount of water the whole-legume food product is configured to absorb.

In an embodiment, the instructions include directions to contact the whole-legume food product with water at a temperature and for a time suitable to provide a reconstituted whole-legume food product. In an embodiment, the instructions include directions to place 5 ounces of the whole-legume food product with 1 cup of water in a microwave and heating the whole-legume food product and the water in the microwave for about 6 minutes. In an embodiment, the instructions include directions to contact 5 ounces of the whole-legume food product with 1 cup of boiling water; and heat the whole-legume food product until the water is absorbed into the whole-legume food product. In an embodiment, the directions include instructions to contact 40 ounces of the whole-legume food product with 2 quarts of water in a steam tray; level the whole-legume food product in the steam tray; and heat the whole-legume food product in the steam tray with a steam table until the whole-legume food product reach a temperature of about 172° Fahrenheit. In an embodiment, the directions include instructions to contact 40 ounces of the whole-legume food product with 2 quarts of water in a steam tray; level the whole-legume food product in the steam tray; and heat the whole-legume food product in the steam tray in an oven at about 325° Fahrenheit until the whole-legume food product reach a temperature of about 172° Fahrenheit.

### EXAMPLES

### Example 1: Preparation of Whole-Legume Food Product

The present Example provides a method of preparing a whole-legume food product, in accordance with an embodiment of the disclosure.

Whole legumes, such as whole lentils, are sourced from a producer or wholesaler. The whole legumes are dry cleaned using a color and shape sorter, such as an automated or electronic color and shape sorter. The sorted whole legumes are wet cleaned using a riffle washing machine. The sorted and cleaned whole legumes are soaked in water or an aqueous solution to provide saturated or nearly saturated whole legumes. The whole legumes may be soaked for 4-12 hours, such as approximately 6 hours, in water, such as salted water, having a temperature of about 70 degrees Fahrenheit.

The soaked whole legumes are then cooked under live steam. A schematic illustration of cooking the soaked whole legumes is illustrated in FIGS. 2A-2D. As shown, whole soaked legumes are loaded into a steam cooking vessel, where a steam valve for injecting steam into the vessel is closed and a vent valve for venting steam from the vessel is open. A loading hatch is closed once the soaked whole legumes are loaded into the vessel.

As shown in FIG. 2B, the steam valve is then opened and the vent valve is partially opened. With steam cycling through the vessel, air, including oxygen, is purged from the vessel. Such oxygen, if left in the vessel during cooking, can spoil the whole legumes, such as by oxidizing the whole legumes, or result in under cooking the whole legumes.

Once oxygen is sufficiently purged from the cooking vessel, the vent valve is closed, as illustrated in FIG. 2C. Live steam is supplied to the cooking vessel during cooking. In this regard, the steam valve is shown in FIG. 2C to be open. In an example, the whole legumes are cooked in the cooking vessel with the vent valve closed for 40 minutes at 10 p.s.i.g., although other times, temperatures, and pressures are possible within the methods of the present disclosure.

Such pressure cooking is advantageous in many ways. The advantages of such relatively low-temperature cooking include a reduction or elimination of acrylamides in cooked whole legumes. Cooking at higher temperature for a shorter period of time, particularly, at low moisture levels, has been shown to produce harmful acrylamides in food products as protein within the food product reacts. Additionally, cooking with live steam generates little or no effluent water. Indeed, condensed steam in the cooking vessel during cooking is observed to absorb into the whole legumes when pressure is released from the cooking vessel. In this regard, there is little to no waste or effluent water to treat after cooking. Furthermore, nutrients, both prebiotic, probiotic, and other nutrients, are not leached from the whole legumes and are, thus, retained for consumption and absorption by an end user.

Once cooking is complete, the steam valve is closed and the vent valve is opened, as shown in FIG. 2D, to release pressure from the cooking vessel. A release hatch may be opened to release whole cooked legumes from the cooking vessel for further processing.

The cooked whole legumes are dried, such as at 200° F. for 70 minutes.

The dried cooked whole legumes are sized, such as by grinding, to provide a preferred size distribution, as discussed further herein. As also discussed further herein, such ground whole legumes can include intact whole legumes, as well as whole legumes that have been ground into smaller pieces.

The ground whole legumes are blended with and enrobed in a spice and/or flavoring mixture. Such a mixture can include oil, salt, and flavors/spices, which coat the ground whole legumes.

The ground whole legumes enrobed in the spice/flavoring mixture are packaged, such as in a soft-sided package for shipment, such as either directly to a consumer or to a wholesaler.

### Example 2: Reconstitution of Whole-Legume Food Product—Microwave

1 cup of water (225 grams), and a packet of whole legume food (as prepared in EXAMPLE 1) was placed in a 3-cup capacity bowl. The water and whole-legume food product were microwaved for 3 minutes and subsequently fluffed with fork. The fluffed whole-legume food product was then microwaved for 1 minute.

### Example 3: Reconstitution of Whole-Legume Food Product—Stove-Top

An oven was preheated to 325 degrees Fahrenheit. A 2.6 lb. bag (41.6 oz) of whole legume food (as prepared in EXAMPLE 1) was placed into a full size 2½″ steam table tray. 2 quarts (64 oz) of hot water was added to the whole-legume food product. The whole-legume food product was leveled in the pan, covered with a lid, and placed in oven. When the whole-legume food product reaches 172 degrees Fahrenheit, it was stirred, and allowed to cool. Because the temperature of the reconstituted whole-legume food product is brought to 172 degrees Fahrenheit, this generally constitutes as a “kill step” killing bacteria that may be present in the whole-legume food product, thus improving food safety.

### Example 4: Reconstitution of Whole-Legume Food Product—Steam Table

An oven was preheated to 325 degrees Fahrenheit. A 2.6 lb. bag (41.6 oz) of whole legume food (as prepared in EXAMPLE 1) was placed into a full size 2½″ steam table tray. 2 quarts (64 oz) of hot water was added to the whole-legume food product. The whole-legume food product was leveled in the pan, covered with a lid, and placed in a steam table. The whole-legume food product was heated until it reached 172 degrees Fahrenheit, at which point it was stirred and allowed to cool. Because the temperature of the reconstituted whole-legume food product is brought to 172 degrees Fahrenheit, this generally constitutes as a “kill step” killing bacteria that may be present in the whole-legume food product, thus improving food safety.

In EXAMPLES 1 through 4, the water added to reconstitute the whole-legume food product is less than an amount of water the dried whole-legume food product is configured to absorb. In this regard, the added water represents approximately 62 percent of the whole at the beginning of the reconstitution process. When the reconstitution process is complete, the water content of the whole is about 60.5 percent due to evaporation.

### Example 5: Preparation of Comparative Food Products

The present Example provides preparation techniques for comparative food products, ground proteins in particular, tested in other Examples. These comparative food products include Stop & Shop 85% and 90% Lean Ground Beef, Perdue Ground Chicken, Shady Brook 93% Lean Ground Turkey, Upton's Natural Chorizo Seitan, Lightlife Smart Ground Mexican Crumble, Gardein Beefless Ground, Beyond Meat Beefy Crumble, and Bianco & Sons Italian Sausage.

Six of the ground proteins were cooked in 9″ non-stick pan with ½ teaspoon of olive oil on a high heat gas flame for six minutes. The ground chicken, Beyond Meat and the Gardein were each cooked for only 5 minutes to prevent overcooking. The products were all broken up into moderate size crumbles during the six-minute cook time. All products were approximately 185°-195° F. when they were removed from the pan and placed in a large bowl lined with a paper towel to allow any fat or free moisture to be wicked up. After three minutes the crumble was spread out on a large metal cookie tray to cool for an additional nine minutes. Any large clumps or agglomerations (larger than approximately ¾-1″ in any dimension) were split apart with a spatula while cooling.

### Example 6: Color Testing

The whole-legume food products of the present disclosure, as prepared in EXAMPLES 1-4, and comparative ground meat products were tested for color using a CIELAB color space.

The CIELAB color space (also known as CIEL *a*b* or sometimes abbreviated as simply “lab” color space) is a color space defined by the International Commission on Illumination (CIE) in 1976. It expresses color as three values: L* for the lightness from black (0) to white (100), a* from green (−) to red (+), and b* from blue (−) to yellow (+). CIElAB was designed so that the same amount of numerical change in these values corresponds to roughly the same amount of visually perceived change.

Because three parameters are measured, the space itself is a three-dimensional real number space, which allows for infinitely many possible colors. In practice, the space is usually mapped onto a three-dimensional integer space for digital representation, and thus the 1*, a*, and b* values are usually absolute, with a pre-defined range. The lightness value, L*, represents the darkest black at 1*=0, and the brightest white at 1*=100. The color channels, a* and b*, represent true neutral gray values at a*=O and b*=0. The a* axis represents the green-red component, with green in the negative direction and red in the positive direction. The b* axis represents the blue-yellow component, with blue in the negative direction and yellow in the positive direction. The scaling and limits of the a* and b* axes will depend on the specific implementation, as described below, but they often run in the range of ±100 or −128 to +127 (signed 8-bit integer).

The ingredients of the tested food products of the present EXAMPLE are summarized in TABLE 2

Ingredient Comparison

| | | Whole-legume food |
|---|---|---|
| Taco Bell Beef | Del Taco Beef | product |
| Beef | Beef | Cooked/Dried Lentils |
| Water | Water | Sunflower Oil |
| Cellulose | Soy Flour | Yeast Extract |
| Chili Pepper | Caramel Color | Garlic |
| Maltodextrin | Onions | Onion |
| Salt | Salt | Salt |
| Oats | Chili Pepper | Cumin |
| Soy Lecithin | Spices | Paprika |
| Spices | Tomato Powder | Red Pepper |
| Tomato Powder | Garlic Powder | Black Pepper |
| Sugar | Hydrolyzed Corn | |
| | Gluten | |
| Onion powder | Wheat Protein | |
| Citric Acid | Soy Protein | |
| Natural flavors | Silicon Dioxide | |
| (including smoke flavor) | | |
| Torula yeast | Autolyzed Yeast | |
| | Extract | |
| Cocoa | Sugar | |
| Disodium inosinate | Citric Acid | |
| and guanylate | | |
| | Sodium Diacetate | |
| | Malic Acid | |
| | Oats | |
| | Isolated Oat Product | |
| | Caramel Color | |

### Definitions

Color measurement principle: The system uses the L, a*, b* color scale as a means of measuring the color of materials, where:

L refers to measuring lightness and varies from 100 (white) to zero (black);

a* refers to measuring redness when plus (+), gray when zero and greenness when minus (−); and

b* refers to measuring yellowness when plus (+), gray when zero (0), and blueness when minus (−).

Test Equipment and Materials

Hunter Lab ScanXE: the Lab Scan XE can be used to measure the color of a variety of products. Its 0°/45° geometry “sees” color the way the human eye sees color, its circumferential viewing reduces the effect of sample directionally by detecting the light evenly from the entire measure surface, and its specular excluded mode takes into account the entire appearance of samples, including the color component and the geometric component (gloss and texture).

Sample Cuvette

Standardized Black Glass Tile

Standardized White Tile (Hunter lab white color tile standard X 80.21, Y 85.02, Z 90.15)

Standardization

Standardization of the Hunter Lab ScanXE was performed as follows according to manufacturer and instrument instructions. In this regard, the black standard was placed at the reflectance port (shiny side down), and the cuvette was carefully filled with sample. The cuvette was placed at reflectance port and covered with black cover. Color measurements were performed on covered cuvette.

Performing Color Test

The prepared sample was placed in a clean 60×35 glass sample cuvette. Color tests were performed when a temperature of the whole-legume food product is was in a range of 120-130° F. to prevent breakage of the cuvette.

The sample port was uncovered, the sample cuvette was placed over the port, and the cover put back on. The test was run using the EasyMatchQC software. The sample was uncovered and the cuvette was turned ⅓ of a rotation, then the cover was replaced. This process was repeated three times to perform the experiment in triplicate. Running each sample 3 times with ⅓ turns in between gives a more accurate reading by averaging the 3 tests done from different positions.

### Results

As shown in FIGS. 3A-3C and summarized in TABLE 3, the whole-legume food product as prepared in EXAMPLE 1 and reconstituted in EXAMPLES 2-4 have a CIELAB color substantially similar to ground beef, as prepared in EXAMPLE 5. Such similar color characteristics provide organoleptic qualities to the whole-legume food product analogous to ground meat.

TABLE 3
L *a*b* Color Space Values

| Product | L* | a* | b* |
|---|---|---|---|
| Ground Beef | 39.57 | 20.24 | 39.58 |
| (Seasoned) | | | |
| Whole-legume Food | 38.91 | 10.43 | 24.07 |
| Product (Seasoned) | | | |
| Ground Beef | 38.93 | 7.68 | 19.37 |
| (Unseasoned) | | | |
| Whole-legume Food | 43.4 | 4.75 | 14.86 |
| Product (Unseasoned) | | | |

### Example 7: Wet Sieve Analysis

The present Example describes wet sieve analysis of the whole-legume food products prepared according to EXAMPLE 1.

Wet sieving is a procedure used to evaluate particle size distribution or gradation of granular material. It's also used to prepare a granular material for particle size analysis by removing fines that may impede the separation process. Wet sieving is an advantageous sample preparation process for specimens with a high fraction of granular materials and enough fines content present to make sieving difficult. The fines can stick together in clumps, preventing an accurate assessment by sieving.

The Wet-Wash method, described in further detail below, involves agitating the samples as it is sprayed with water or while it is in a water suspension. The agitation is often done by hand using a sieve or multiple sieves under water running from a faucet or dispersed through a spray fixture. Mesh sizes for these sieves are selected based on application requirements for particle sizes to retain.

It is important to be aware that any wet sieving method has the potential for sample loss during the process. Some material may be washed away during agitation or decanting or may be forced into crevices of the sieve and become trapped. The percentage loss is very small, and the accuracy and efficiency of wet sieving compared to dry sieving is worth the process, if necessary, for the application.

Wet sieving can be performed according to the following method.

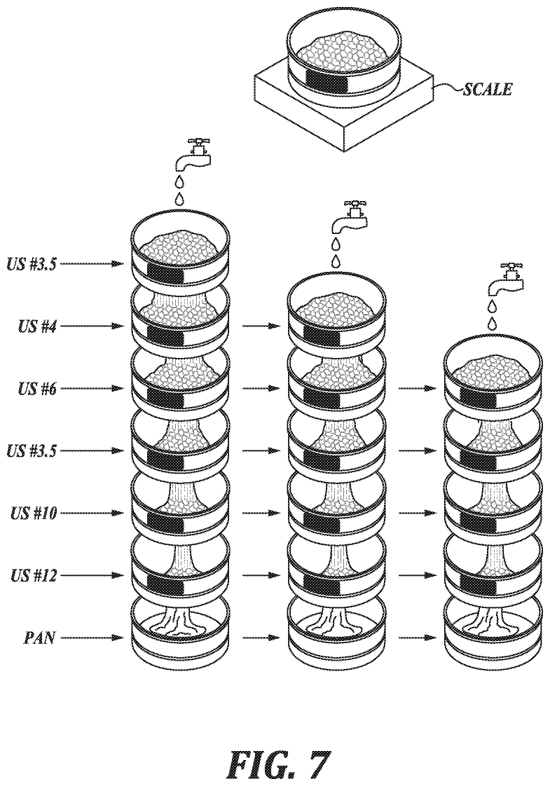

Determine total sample weight before beginning the process for use in determining weight for final calculation. Select appropriate sieve sizes for the sample to be tested and stack them with the biggest mesh size on top and the next smallest sieve size underneath it. Typical sieve sizes used for the prepared whole-legume food product are US #3.5, US #4, US #6, US #8, US #10, and US #12. An exemplary set of sieves for wet sieve analysis is shown in FIG. 7.

Place sieve stack in the sink or wash basin and add the sample to the top sieve. Turn on the water and gently rinse the sample over the screen for several minutes, moving the sieve around to agitate the whole sample over the screen. Nozzles or sprayers are used to disperse water and evenly wet the sample during sieving or agitation. Gentle, controlled water pressure is used to prevent accidental sample loss.

Remove the top screen and repeat the above step for all screens used in the analysis. Once the sample has been agitated through all the screens, collect samples one at a time (keeping them separate) out of the sieves onto a paper towel to absorb the remaining moisture. Take care to note which sieve each portion of sample came out of.

Let samples dry to ensure any water used for agitation is absorbed or evaporated out. Weigh each sample, then add all samples to get total sample weight. Compare to initial sample weight, should be similar.

Divide each sample weight by the total sample weight to get each amount in percentages. Record the results on the worksheet in the sieve analysis binder.

As shown in FIG. 4, the ground whole legumes have a size distribution similar to prepared ground beef within acceptable ranges. Such a particle size distribution analogous to prepared ground beef provides a consumer with organoleptic qualities resembling ground beef, or other ground meat proteins. In this regard, the whole legumes of the present disclosure are meat analogues.

### Example 8: Resilience and Instant Springback Testing

In this Example, whole-legume food products as prepared in EXAMPLES 1-5 were tested for firmness, resilience, and instant springback.

Specifically, these food products were tested using a TA-040SQFL-G test set-up from Texture Technologies (Hamilton, Mass.). The TA-040SQFL-G is a set of aluminum 4″-diameter plates, which have a grid pattern to grab a product placed therebetween to prevent it from barreling out excessively during compression. The upper platen is calibrated against the lower platen and tests are conducted to a constant gap or to a constant strain. The TA-040SQFL-G fixture measures the firmness, resilience, and instant springback. Resilience and instant springback are metrics that quantify how a food product, such as ground proteins, fight to regain their shape and how much of their initial height is immediately recovered. Food products that are generally more resilient and exhibit more instant springback will be evaluated by a consumer to be, for example, rubbery, gristly, chewy, or tough.

The food products, as prepared in EXAMPLES 1-5, were placed with a spatula onto a weigh boat and fifty grams of food product was measured out and placed on the lower platen with the help of a 3¾″ diameter ring. The food product was evenly distributed within the ring without compressing the product. The ring was removed before testing. Five replicates were completed within 5-9 minutes for each of three cooking batches. At time of testing most products were between 73° to 75° F. The ambient temperature was 73°-74° F. so the replicates were fairly stable at time of the test.

The test settings were Return to Start in Compression with a Button Trigger. The Test Speed was 3 mm/second. The upper platen was calibrated and positioned at precisely 130 mm over the bottom platen as a starting position. When the test was initiated the upper plate quickly moved to 25 mm over the base (shown below left) at 20 mm/sec. After a delay of 1 second to dissipate inertia, data collection was enabled and the fixture travelled the Target Distance of 20 mm, leaving a final 5 mm gap between the plates. The Post-Test Speed was also set at 3 mm/second so the energy and height recovery could be contrasted with the downstroke behavior. After the upper plate returned to the 25 mm position data collection was turned off and the fixture automatically repositioned to the 130 mm starting position at 20 mm/sec. The fixture was wiped clean between replicates using a soapy scrubber with warm water when necessary. The plates were dried before each replicate.

This method very successfully measured firmness, resilience (% work recovery) and instant springback (% height recovery) with very moderate % cv values considering the inherent geometry variability of the ground proteins.

The repeatability of the firmness metric (absolute peak compression force) is very strong across all ground proteins. The behavioral metrics (resilience and instant springback) were all excellent; such tight reproducibility allows for better discrimination between different formulations, cooking procedures, and sample presentation techniques.

TABLE 4
Absolute peak compression force, resilience,
and instant springback of ground proteins.

| | Absolute peak | | | Instant |
|---|---|---|---|---|
| Ground Proteins - | compression force | | Resilience | Springback |
| TA-040SQFL-G | (kg) (% cv) | | (ratio) (% cv) | (ratio) (% cv) |
| 85% Lean Beef | 32.05 | (23%) | 31.0% (1.1%) | 50.5% (4.9%) |
| 90% Lean Beef (n = 4) | 34.79 | (28%) | 35.3% (2.0%) | 52.0% (2.3%) |
| Gardein Beefless Ground | 38.13 | (6%) | 31.8% (1.1%) | 41.6% (5.5%) |
| Perdue Ground Chicken | 37.00 | (3%) | 32.0% (2.3%) | 51.7% (3.2%) |
| Shady Brook 93% Lean Ground | 36.11 | (9%) | 32.6% (2.5%) | 51.8% (4.7%) |
| Turkey | | | | |
| Upton's Natural Chorizo Seitan | 41.80 | (11%) | 43.7% (1.7%) | 63.6% (5.2%) |
| Lightlife Smart Ground | 23.68 | (6%) | 25.6% (2.4%) | 35.2% (3.2%) |
| Crumbles | | | | |
| Beyond Meat Beefy Crumble | 19.70 | (9%) | 32.3% (1.8%) | 49.6% (11.4%) |
| Bianco & Sons Italian Sausage | 44.49 | (6%) | 34.2% (3.5%) | 54.0% (3.3%) |
| Whole-legume food product | 16.82 | (19.7%) | 14.8% (12.9%) | 27.4% (7.8%) |

The whole-legume food product prepared according to EXAMPLES 1-5 were prepared to have a particle size distribution on the lower end of a preferred ranges and, accordingly, had a firmness, when reconstituted, on a lower end of a preferred range when compared to prepared ground meat and other meat analogs. The firmness of the whole-legume food product can be increased by, for example, shifting a particle size distribution of the whole-legume food product to have a greater proportion of larger-sized particles and fewer smaller-sized particles. In this regard, the whole-legume food products of the present disclosure can have a firmness that is equal to or greater than cooked ground meat when the particle size distribution of the whole-legume food product has a relatively large proportion of larger-sized particles derived from whole legumes.

### Example 9: Firmness Testing

In the present Example, whole-legume food products prepared according to EXAMPLES 1-5 were tested for firmness.

Specifically, a TA-93WST Wire Screen Forward Extrusion rig, from Texture Technologies (Hamilton, Mass.) was used to test firmness. The TA-93WST includes a barrel with a stainless-steel wire screen bottom across which materials are initially compressed and then sheared.

The same preparation and cooking procedure was used for testing the firmness of whole-legume food product and other ground proteins with the TA-093 Wire Screen Extrusion fixture as in EXAMPLE 8. This test method is designed for firmness and will not generate meaningful metrics for resilience, springback and other textural behaviors. The plunger height was calibrated against the wire screen. The plunger was then set to an exact height of 80.0 mm before each test. The test settings were: 3.0 mm/sec Test Speed, 10.0 mm/sec Post-Test Speed, 75.0 mm Target Distance, and a Button Trigger. The test begins by compacting slightly the ground proteins. The compaction continues until enough force is built up to shear the crumble. Shear behaviors start at approximately 12 seconds for these tests. A macro captured the absolute peak compression force and the mean extrusion force of the ground proteins from 55 mm to 74 mm of extrusion. The whole-legume food product plots compacted early and then extruded for a steady state longer than other ground proteins in the study, so we slightly increased the span over which we calculated the mean extrusion force.

These tests were conducted approximately 1 hour and 3 hours after finishing the microwave cooking process. In both instances the cooked samples were allowed to reach room temperature (˜73-74° F.) before they were tested.

TABLE 5

| | | | Absolute peak |
|---|---|---|---|
| | | Mean force | compression |
| | | (55 mm-74 mm) | force |
| | | kg | kg |
| BATCH TESTED AFTER 1 HOUR | | | |
| Whole-legume food product -100 grams03 | | 9.96 | 10.66 |
| Whole-legume food product -100 grams02 | | 9.95 | 10.92 |
| Whole-legume food product -100 grams05 | | 9.52 | 10.16 |
| Whole-legume food product -100 grams04 | | 9.05 | 9.74 |
| | Average: | 9.62 | 10.37 |
| | S.D. | 0.43 | 0.53 |
| | % CV | 4.5% | 5.1% |
| BATCH TESTED AFTER 3 HOURS | | | |
| Whole-legume food product -100 grams 3 hrs09 | | 9.61 | 10.10 |
| Whole-legume food product -100 grams 3 hrs08 | | 9.30 | 10.11 |
| Whole-legume food product -100 grams 3 hrs07 | | 9.29 | 10.39 |
| Whole-legume food product -100 grams 3 hrs06 | | 10.68 | 11.30 |
| | Average: | 9.72 | 10.47 |
| | S.D. | 0.66 | 0.57 |
| | % CV | 6.7% | 5.4% |

The tests were indicated that the whole-legume food product sheared in a manner that was extremely repeatable within each batch and also between the two batches. Over the additional 2 hour resting time at room temperature the whole-legume food product samples entirely retained their shear strength. As a result, the shear results can also be shown in the following table in a unified table. The larger number of samples confirmed the % cv and did not reduce the observed standard deviation. That suggests that an N=8 is not necessary and that the batch can be nicely represented with an N=4 (or perhaps and N=3).

As above, the whole-legume food products of the present EXAMPLE were prepared to have a particle size distribution with a relatively large proportion of smaller-sized particles, and, accordingly, have a firmness that is generally lower than cooked ground meat and other meat analogs. The firmness of the whole-legume food products according to the present disclosure can be modulated, such as increased, by changing a particle size distribution of the whole-legume food product.

FIG. 6 and TABLE 5 show that the reconstituted whole-legume food products of the present EXAMPLE have a firmness that is relatively constant after reconstitution. In this regard, samples were tested for firmness 1 hour and 3 hours after finishing the microwave cooking process. As shown, the firmness between the two batches of tests are very similar. The firmness of, for example, ground meat changes over time with a firmness generally increasing over time after cooking/preparation. In this regard, the whole-legume food products of the present disclosure advantageously maintain a firmness over time after preparation. This provides an advantage to those preparing and serving the whole-legume food product in that they have a larger time window in which to serve the whole-legume food product after reconstituting it while maintaining a desired firmness.

### Example 10: Oil Retention

The present Example demonstrates oil retention capabilities of the whole-legume food product of the present disclosure and a conventional meat analog.

100 g of a whole-legume food product according to EXAMPLE 1 and a textured vegetable protein (TVP) were separately soaked in 400 g of boiling water for 30 minutes. Any remaining effluent water was drained after 30 minutes to provide a reconstituted whole-legume food product and a reconstituted TVP.

The reconstituted whole-legume food product and TVP were contacted with vegetable oil at room temperature for 30 minutes to allow the reconstituted whole-legume food product and TVP to absorb the oil. This was performed using a number of different weights of oil, as summarized in TABLE 6. A maximum oil absorption/retention was indicated where oil pooled in the bottom of a bowl when the reconstituted oil-soaked food product was moved to the side of the bowl.

As shown in TABLE 6, the whole-legume food product of the present disclosure absorbs more oil than the TVP on a w/w % basis. In this and other regards, the whole-legume food product is a better meat extender, fortifier, etc. in that it can absorb or otherwise retain a greater amount of oil than the TVP.

TABLE 6

| | Mass Oil (g) | Mass Water (g) | Total Mass (g) |
|---|---|---|---|
| TVP | | | |
| #1 | 5 | 258 | 363 |
| #2 | 10 | 255 | 363 |
| #3 (Max) | 14.28 | 248.72 | 363 |
| GroundPro | | | |
| #1 | 5 | 258 | |
| #2 | 10 | 255 | 363 |
| #3 | 15 | 248 | 363 |
| #4 | 15 | 248 | 363 |
| #5 | 20 | 243 | 363 |
| #6 (Max) | 27 | 236 | 363 |

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. The term “about” means plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A whole-legume food product comprising:
dried cooked whole legumes; and
a flavoring mixture enrobing the dried cooked whole legumes.

2. The whole-legume food product of claim 1, wherein the whole-legume food product has an absolute peak compression force in a range of about 15 kg to about 40 kg, as measured with Texture Technologies TA-040SQFL-G plate.

3. The whole-legume food product of claim 1, wherein the whole-legume food product has an absolute peak compression force of in a range of about 10 kg to about 40 kg, as measured with a Texture Technologies TA-93WST Wire Screen Forward Extrusion rig.

4. The whole-legume food product of claim 1, wherein the whole-legume food product has a resilience in a range of about 10% to about 35%, as measured with Texture Technologies TA-040SQFL-G plate.

5. The whole-legume food product of claim 1, wherein the whole-legume food product has an instant springback in a range of about 20% to about 55%, as measured with Texture Technologies TA-040SQFL-G plate.

6. The whole-legume food product of claim 1, the whole-legume food product has an L* value in a CIELAB color space in a range of about 38 to about 44.

7. The whole-legume food product of claim 1, the whole-legume food product has an a* value in a CIELAB color space in a range of about 4 to about 11.

8. The whole-legume food product of claim 1, the whole-legume food product has a b* value in a CIELAB color space in a range of about 14 to about 25.

9. The whole-legume food product of claim 1, wherein the whole-legume food product further comprises ground whole-legumes comprising portions of whole legumes.

10. The whole-legume food product of claim 9, wherein the ground whole legumes have a particle size distribution wherein:
greater than 0 w/w % to about 10 w/w % of the ground whole legumes have a largest dimension in a range of about 0.223 inches to about 0.187 inches;
about 5 w/w % to about 20 w/w % of the ground whole legumes have a largest dimension in a range of about 0.187 inches to about 0.132 inches;
about 5% to about 25 w/w % of the ground whole legumes have a largest dimension in a range of about 0.132 inches to about 0.0937 inches;
about 27.5 w/w % to about 37.5 w/w % of the ground whole legumes have a largest dimension in a range of about 0.0937 inches to about 0.0787 inches;
about 10 w/w % to about 22.5 w/w % of the ground whole legumes have a largest dimension in a range of about 0.0787 inches to about 0.0661 inches; and
about 2.5 w/w % to about 12.5 w/w % of the ground whole legumes have a largest dimension smaller than about 0.0661 inches.

11. The whole-legume food product of claim 1, wherein the whole-legume food product has a water content in a range of about 3 wt % to about 9 wt %.

12. The whole-legume food product of claim 11, wherein the whole-legume food product has a water content in a range of about 6 wt % to about 7 wt %.

13. The whole-legume food product of claim 1, wherein the flavoring mixture comprises an oil.

14. The whole-legume food product of claim 1, wherein the dried cooked whole legumes include dried cooked lentils.

15. The whole-legume food product of claim 1, wherein the whole-legume food product is disposed in a package.

16. The whole-legume food product of claim 15, wherein the package includes instructions for preparation of a reconstituted whole-legume food product from the whole-legume food product.

17. The whole-legume food product of claim 16, wherein the instructions include instructions to reconstitute the whole-legume food product including contacting the whole-legume food product with an amount of water less than an amount of water the whole-legume food product is configured to absorb.

18. The whole-legume food product of claim 1, wherein the whole-legume food product comprises a gum or a modified starch

19. The whole-legume food product of claim 1, wherein whole-legume food product is configured to absorb oil in a range of 20 w/w % to about 40 w/w %.

20. The whole-legume food product of claim 1, wherein the whole-legume food product is configured to absorb about 21 w/w % oil.

21. The whole-legume food product of claim 1, wherein the whole-legume food product is free or substantially free of soy.

22. The whole-legume food product of claim 1, wherein the whole-legume food product is free or substantially free of genetically modified organisms.

23. The whole-legume food product of claim 1, further comprising a meat product.
